(19) United States
(12) Patent Application Publication
(10) Pub. No.: US 2022/0279507 A1
(43) Pub. Date: Sep. 1, 2022

(54) TERMINAL AND RADIO COMMUNICATION METHOD

(71) Applicant: NTT DOCOMO, INC., Tokyo (JP)

(72) Inventors: Yuki Takahashi, Tokyo (JP); Satoshi Nagata, Tokyo (JP); Xiaohong Zhang, Beijing (CN); Lihui Wang, Beijing (CN); Shaozhen Guo, Beijing (CN); Xiaolin Hou, Beijing (CN)

(73) Assignee: NTT DOCOMO, INC., Tokyo (JP)

(21) Appl. No.: 17/633,057

(22) PCT Filed: Aug. 7, 2019
(86) PCT No.: PCT/JP2019/031232

§ 371 Date: Feb. 4, 2022

(51) Int. Cl. H04W 72/04

(52) U.S. Cl. CPC H04W 72/0413

(57) ABSTRACT

A terminal according to one aspect of the present disclosure includes a control section that selects an uplink control channel resource included in a specific uplink control channel resource set when a first uplink control channel resource for first uplink control information corresponding to a first type and a second uplink control channel resource for second uplink control information corresponding to a second type collide with each other, and a transmitting section that transmits the first uplink control information and the second uplink control information by using the selected uplink control channel resource.

### TECHNICAL FIELD

The present disclosure relates to a terminal and a radio communication method in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (e.g., referred to as “5th generation mobile communication system (5G),” “5G+ (plus),” “New Radio (NR),” “3GPP Rel. 15 (or later versions),” and so on) are also under study.

In existing LTE systems (e.g., LTE Rel. 8 to Rel. 14), a user terminal (User Equipment (UE)) controls reception of a downlink shared channel (e.g., a Physical Downlink Shared Channel (PDSCH)) on the basis of downlink control information (also referred to as DCI, DL assignment, and so on) transmitted via a downlink control channel (e.g., a Physical Downlink Control Channel (PDCCH)). The user terminal also controls transmission of an uplink shared channel (e.g., a Physical Uplink Shared Channel (PUSCH)) on the basis of DCI (also referred to as UL grant and so on).

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

In future radio communication systems (e.g., 5G, NR, and the like), it is assumed that a plurality of traffic types (also referred to as services, types, service types, communication types, use cases, or the like) with different requirements, such as high speed and large capacity (e.g., eMBB (enhanced Mobile Broad Band)), massive terminals (e.g., mMTC (massive Machine Type Communication) or IoT (Internet of Things)), ultra-high reliability and low latency (e.g., URLLC (Ultra Reliable and Low Latency Communications)), coexist.

When a UE supports (or uses) the plurality of the traffic services, it is assumed that collision between a plurality of uplink transmissions each associated with a different traffic type occurs. However, how to process such a plurality of uplink transmissions is indefinite. Unless the process is definite, deterioration of system performance, such as being incapable of satisfying requirements of a specific traffic type, may occur.

The present invention has been made in view of the above-described respects, and an object of the present invention is to provide a terminal and a radio communication method that can appropriately perform communication even when a plurality of uplink transmissions each associated with a different traffic type collide with each other.

### Solution to Problem

A terminal according to one aspect of the present disclosure includes a control section that selects an uplink control channel resource included in a specific uplink control channel resource set when a first uplink control channel resource for first uplink control information corresponding to a first type and a second uplink control channel resource for second uplink control information corresponding to a second type collide with each other, and a transmitting section that transmits the first uplink control information and the second uplink control information by using the selected uplink control channel resource.

### Advantageous Effects of Invention

According to one aspect of the present disclosure, it is possible to appropriately perform communication even when a plurality of uplink transmissions each associated with a different traffic type collide with each other.

### BRIEF DESCRIPTION OF DRAWINGS

FIG. 1 is a diagram to show an example of HARQ-ACK transmission to a PDSCH;

FIG. 2 is a diagram to show an example of configurations of PUCCH resource sets;

FIG. 3 is a diagram to show an example of PUCCH resources designated by DCI;

FIG. 4 is a diagram to show an example of a case where PUCCHs corresponding to different transmission types collide with each other;

FIG. 5 is a diagram to show an example of a method for selecting PUCCH resource sets and PUCCH resources;

FIG. 6 is a diagram to show another example of the method for selecting PUCCH resource sets and PUCCH resources;

FIG. 7 is a diagram to show another example of the method for selecting PUCCH resource sets and PUCCH resources;

FIG. 8 is a diagram to show another example of the method for selecting PUCCH resource sets and PUCCH resources;

FIG. 9 is a diagram to show another example of the method for selecting PUCCH resource sets and PUCCH resources;

FIG. 10 is a diagram to show another example of the method for selecting PUCCH resource sets and PUCCH resources;

FIG. 11 is a diagram to show another example of the method for selecting PUCCH resource sets and PUCCH resources;

FIG. 12 is a diagram to show an example of a schematic structure of a radio communication system according to one embodiment;

FIG. 13 is a diagram to show an example of a structure of a base station according to one embodiment;

FIG. 14 is a diagram to show an example of a structure of a user terminal according to one embodiment; and

FIG. 15 is a diagram to show an example of a hardware structure of the base station and the user terminal according to one embodiment.

### DESCRIPTION OF EMBODIMENTS

<Service (Traffic Type)>

In future radio communication systems (e.g., NR), traffic types (also referred to as types, services, service types, communication types, use cases, or the like), such as further enhancement of mobile broadbands (e.g., enhanced Mobile Broadband (eMBB)), machine type communication to achieve simultaneous multiple connections (e.g., massive Machine Type Communications (mMTC) or Internet of Things (IoT)), high-reliability and low-latency communication (e.g., Ultra-Reliable and Low-Latency Communications (URLLC)), are assumed. For example, URLLC demands shorter latency and higher reliability than those of eMBB.

In a physical layer, the traffic types may be identified on the basis of at least one of the following.
a logical channel having different priority,
a modulation and coding scheme (MCS) table (MCS index table),
a channel quality indication (CQI) table,
a DCI format,
(radio network temporary identifier (RNTI, System Information-Radio Network Temporary Identifier)) used for scrambling (masking) of cyclic redundancy check (CRC) bits included (added) in the DCI (DCI format),
an RRC (Radio Resource Control) parameter,
a specific RNTI (e.g., an RNTI for URLLC, an MCS-C-RNTI, or the like),
a search space, and
a given field in DCI (e.g., a newly added field or reuse of an existing field).

Specifically, the traffic types of HARQ-ACK (or PUCCH) to a PDSCH may be determined on the basis of at least one of the following.
an MCS index table used for determination of at least one of modulation order of the PDSCH, a target code rate, and a transport block size (TBS) (e.g., whether MCS index table 3 is used),
an RNTI used for CRC scrambling of DCI used for scheduling of the PDSCH (e.g., which of a C-RNTI or an MCS-C-RNTI is used for CRC scrambling), and
priority configured by higher layer signaling.

The traffic types may be associated with communication requirements (requirements or required conditions, such as latency and an error rate), data types (voice, data, or the like), or the like.

Difference between requirements of URLLC and requirements of eMBB may be the case that latency of URLLC is shorter than latency of eMBB, or may be the case that the requirements of URLLC include requirements of reliability.

For example, requirements of user (U) plane latency of eMBB may include the case that downlink U plane latency is 4 ms and uplink U plane latency is 4 ms. On the other hand, requirements of U plane latency of URLLC may include the case that downlink U plane latency is 0.5 ms and uplink U plane latency is 0.5 ms. Requirements of reliability of URLLC may include the case that a 32-byte error rate is 10⁵ at 1 ms U plane latency.

As enhanced Ultra Reliable and Low Latency Communications (eURLLC), enhancement of reliability of traffics for unicast data is mainly under study. Hereinafter, when URLLC and eURLLC are not distinguished from each other, these are simply referred to as URLLC.

### <PUCCH Resource>

In existing radio communication systems (e.g., Rel. 15), a PUCCH resource used for transmission of HARQ-ACK for DL transmission (e.g., a PDSCH) is determined on the basis of information notified by each of DCI and higher layer signaling. For example, a UE may determine the PUCCH resource used for the transmission of the HARQ-ACK by using the following steps 1 to 3. Note that sequence of steps 1 to 3 may be switched.

### [Step 1]

In step 1, the UE or terminal (also hereinafter simply described as UE) determines an HARQ-ACK feedback timing (K1). K1 corresponds to a period (e.g., a slot) from reception of DL transmission (e.g., a PDSCH) until transmission of HARQ-ACK for the DL transmission. Information related to the HARQ-ACK feedback timing (K1) may be included in DCI used for scheduling of the PDSCH.

A network (e.g., a base station) may notify the UE of K1 by using a given field of the DCI (or PDCCH) to schedule the PDSCH. For example, a bit value designated by the given field of the DCI may be associated with a given value (e.g., {1, 2, 3, 4, 5, 6, 7, 8}). Alternatively, the bit value designated by the given field of the DCI may be associated with a value configured by higher layer signaling.

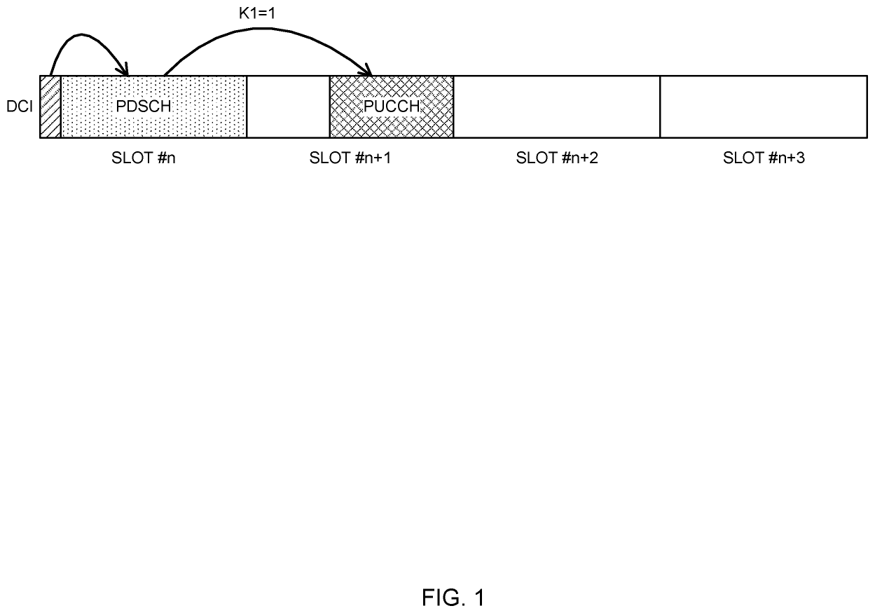

When receiving DCI to schedule a PDSCH, the UE judges a timing of HARQ-ACK feedback for the PDSCH on the basis of information included in the DCI (see FIG. 1). In FIG. 1, the UE receives, on the basis of DCI transmitted in slot #n, a PDSCH to be scheduled in the same slot #n. The UE performs, on the basis of information related to the HARQ-ACK feedback timing (here, K1=1) included in the DCI, transmission of the HARQ-ACK by using a PUCCH resource configured in slot #n+1.

### [Step 2]

In step 2, the UE determines a PUCCH resource set used in a slot for transmitting HARQ-ACK.

One or more PUCCH resource sets are notified (or configured) to the UE by higher layer signaling. The PUCCH resource set may include one or more PUCCH resources. For example, K (e.g., 1≤K≤4) pieces of PUCCH resource sets may be notified to the UE from the base station. Each PUCCH resource set may include M (e.g., 8≤M≤32 or 1≤M≤8) pieces of PUCCH resources.

The UE may determine a single PUCCH resource set out of K pieces of configured PUCCH resource sets on the basis of a size of a UCI payload (UCI payload size). The UCI payload size may be the number of UCI bits not including cyclic redundancy check (Cyclic Redundancy Code (CRC)) bits.

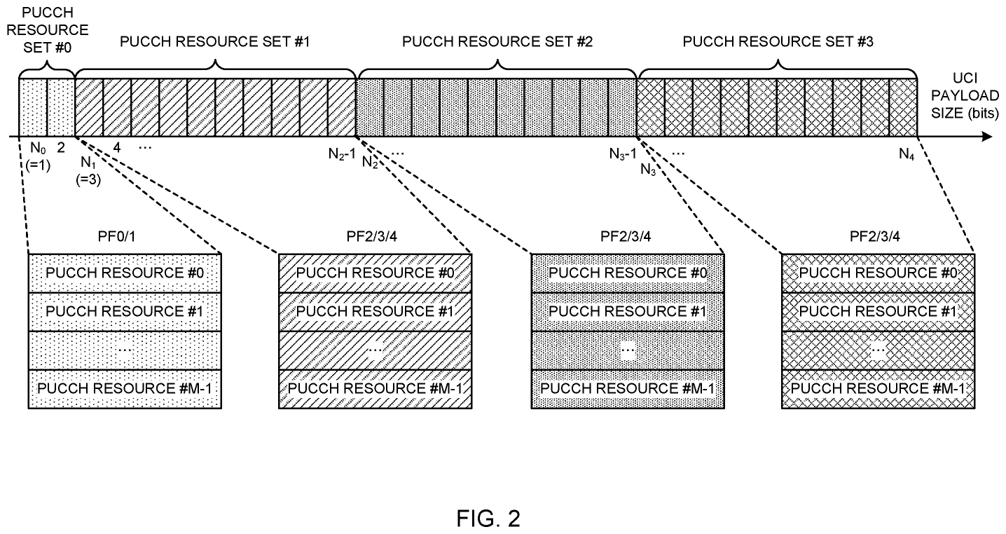

FIG. 2 is a diagram to show an example of PUCCH resource allocation. In FIG. 2, as an example, it is assumed that K=4 and four PUCCH resource sets #0 to #3 are configured for the UE by higher layer signaling from the base station. It is also assumed that each of PUCCH resource sets #0 to #3 includes M (e.g., 8≤M≤32) pieces of PUCCH resources #0 to #M−1. Note that the numbers of PUCCH resources included by each PUCCH resource set may be the same, or may be different from each other.

In FIG. 2, each PUCCH resource configured for the UE may include a value of at least one of the following parameters (also referred to as fields, information, or the like). Note that a value range capable of being taken for each PUCCH format may be defined for each parameter.
a symbol at which PUCCH allocation is started (start symbol),
the number of symbols allocated to a PUCCH in a slot (period allocated to the PUCCH),
an index of a resource block (physical resource block (PRB)) in which PUCCH allocation is started,
the number of PRBs allocated to the PUCCH,
whether frequency hopping is enabled for the PUCCH,
an index of a second hop frequency resource or initial cyclic shift (CS) in a case where the frequency hopping is enabled,
an index of an orthogonal spreading code (e.g., Orthogonal Cover Code (OCC)) in a time domain (time-domain) or a length of OCC (also referred to as an OCC length, a spreading rate, or the like) used for block-wise spreading before discrete Fourier transform (DFT), and
an index of OCC used for block-wise spreading after DFT.

As shown in FIG. 2, when PUCCH resource sets #0 to #3 are configured for the UE, the UE selects any one of PUCCH resource sets on the basis of the UCI payload size.

For example, when the UCI payload size is 1 or 2 bits, PUCCH resource set #0 is selected. When the UCI payload size is 3 bits or more and N₂−1 bits or less, PUCCH resource set #1 is selected. When the UCI payload size is N₂ bits or more and N₃−1 bits or less, PUCCH resource set #2 is selected. Similarly, when the UCI payload size is N₃ bits or more and N₃−1 bits or less, PUCCH resource set #3 is selected.

As described above, a range of the UCI payload size for which PUCCH resource set #i (i=0, . . . , K−1) is selected is denoted as Nᵢ bits or more and Nᵢ₊₁−1 bits or less (that is, {Nᵢ, . . . , Nᵢ₊₁−1}bits).

Here, start positions (start bit numbers) N₀ and N₁ of the UCI payload size for PUCCH resource sets #0 and #1 may be 1 and 3, respectively. Therefore, PUCCH resource set #0 is selected when UCI being 2 bits or less is transmitted, and thus PUCCH resource set #0 may include PUCCH resources #0 to #M−1 for at least one of PF 0 and PF 1. On the other hand, any one of PUCCH resource sets #1 to #3 is selected when UCI more than 2 bits is transmitted, and thus each of PUCCH resource sets #1 to #3 may include PUCCH resources #0 to #M−1 for at least one of PF 2, PF 3, and PF 4.

When i=2, . . . , K−1, information (start position information) indicating a start position (Nᵢ) of the UCI payload size for PUCCH resource set #i may be notified to (or configured for) the UE with use of higher layer signaling. The start position (Nᵢ) may be UE-specific. For example, the start position (Nᵢ) may be set to values ranging from 4 bits to 256 bits (e.g., a multiple of 4). For example, in FIG. 2, each piece of information indicating start positions (N₂ and N₃) of the UCI payload size for PUCCH resource sets #2 and #3 is notified to the UE with higher layer signaling (e.g., user-specific RRC signaling).

A maximum payload size of UCI for each PUCCH resource set is given by N_{K}−1. N_{K} may be explicitly notified to (configured for) the UE by higher layer signaling and/or DCI, or may be implicitly derived. For example, in FIG. 2, N₀=1 and N₁=3 may be defined by specifications, and N₂ and N₃ may be notified by the higher layer signaling. N₄ may be defined by the specifications (e.g., N₄=1706).

As described above, the UE selects, on the basis of the UCI payload size (e.g., HARQ-ACK bits when the UCI is HARQ-ACK), one PUCCH resource set from one or more PUCCH resource sets configured in a higher layer.

### [Step 3]

In step 3, the UE determines one PUCCH resource from one or more PUCCH resources included in a PUCCH resource set.

For example, the UE may determine, on the basis of at least one of DCI and implicit information (also referred to as implicit indication information, an implicit index, and so on), the PUCCH resource used for UCI transmission out of M pieces of PUCCH resources included in a determined PUCCH resource set.

In a case shown in FIG. 2, the user terminal can determine, on the basis of a value of a given field of the DCI, a single PUCCH resource used for UCI transmission out of PUCCH resources #0 to #M−1 included in the PUCCH resource set selected on the basis of the UCI payload size.

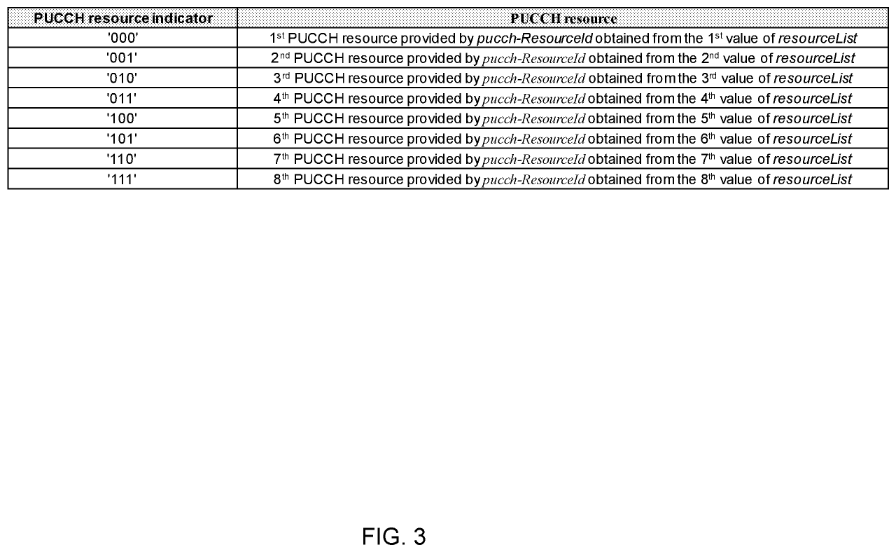

The number of PUCCH resources M in one PUCCH resource set may be configured for the user terminal by higher layer signaling (see FIG. 3). FIG. 3 shows a case where eight PUCCH resources are configured by the higher layer signaling. Here, FIG. 3 shows a case where the PUCCH resources in the PUCCH resource set are notified by a 3-bit field in the DCI, but the number of bits is not limited to this.

Incidentally, in future radio communication systems, it is assumed that one UE supports a plurality of traffic types (or communication services), and a plurality of UL transmissions associated with different traffic types occur. As an example, it is assumed that the UE transmits both UCI (e.g., HARQ-ACK) corresponding to a first traffic type (also hereinafter described as a first type) and UCI (e.g., HARQ-ACK) corresponding to a second type. The second type may correspond to a communication service having lower priority (or allowed to delay) than that of the first type.

In this case, it is also assumed that at least one of a PUCCH resource set and an HARQ-ACK codebook is separately (e.g., differently) configured for each HARQ-ACK corresponding to each service.

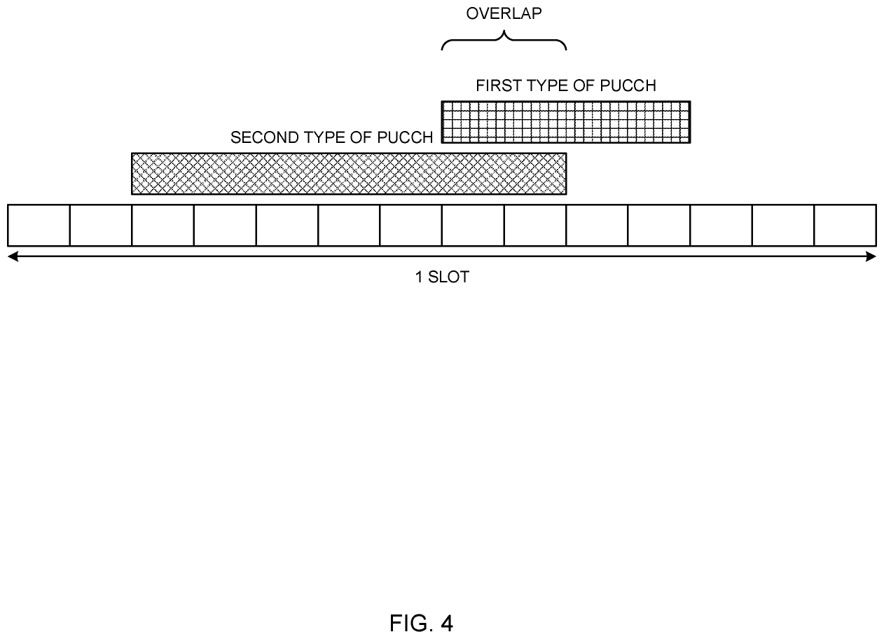

On the other hand, a case where transmission periods for different types of UL channels or UL transmissions overlap with each other is also assumed (see FIG. 4). FIG. 4 shows a case where a PUCCH (or PUCCH resource) configured for a first type (e.g., for URLLC) of HARQ-ACK and a PUCCH (or PUCCH resource) configured for a second type (e.g., for eMBB) of HARQ-ACK overlap with each other in a part of a time domain.

However, how to control when two UL transmissions associated with different traffic types collide with each other is an issue.

For example, it is also assumed that the UE performs transmission by multiplexing or mapping (also hereinafter simply described as multiplexing) the first type of HARQ-ACK and the second type of HARQ-ACK to the same PUCCH resource. However, how to determine a PUCCH resource for multiplexing of different types of HARQ-ACK in such a case is an issue.

Thus, the inventors of the present invention studied a process of collision between UL transmissions associated with different traffic types, and reached the present invention.

Hereinafter, embodiments according to the present disclosure will be described in detail with reference to the drawings. Respective aspects may each be employed individually, or may be employed in combination.

In the present disclosure, a traffic type may indicate one of a plurality of candidates including at least one of URLLC, eURLLC, eMBB, mMTC, IoT, and Industrial Internet of Things (IIoT or IoT for industry). In the present disclosure, a first type, a first traffic type, a high-priority traffic type, URLLC, and eURLLC may be interchangeably interpreted. A second type, a second traffic type, a low-priority traffic type, and eMBB may be interchangeably interpreted. Priority of the second traffic type may be lower than priority of the first traffic type.

In the present disclosure, UL (uplink) information, UL transmission, UCI, a UCI bit, a PUCCH, HARQ-ACK, an HARQ-ACK information bit, an SR, an SR information bit, CSI, a CSI bit, UL data, and a PUSCH may be interchangeably interpreted. The UCI may include at least one of the HARQ-ACK, SR, and CSI. An uplink resource, a PUCCH resource, and a PUSCH resource may be interchangeably interpreted.

In the present disclosure, an information type may indicate one of a plurality of candidates including at least one of UCI, a PUCCH, HARQ-ACK, an SR, CSI, UL data, and a PUSCH, may be interpreted as a UCI type, or may be interpreted as a channel type.

In the present disclosure, collision (collide), conflict, and overlap may be interchangeably interpreted. In the present disclosure, drop, puncture, cancel, and non-transmission may be interchangeably interpreted.

### (First Aspect)

In a first aspect, when UCI (e.g., HARQ-ACK) each corresponding to a different type (e.g., a first type and a second type) is transmitted with use of the same PUCCH resource, the PUCCH resource is determined on the basis of a PUCCH resource set configured for a specific type.

When a PUCCH resource for the first type of UCI and a PUCCH resource for the second type of UCI collide with each other, a UE may control transmission of the first type of UCI and the second type of UCI by using a PUCCH resource included in a specific PUCCH resource set.

The specific PUCCH resource set may be either of one or more PUCCH resource sets configured for the first type and one or more PUCCH resource sets configured for the second type. For example, the UE determines the PUCCH resource on the basis of a PUCCH resource set associated with a specific type out of a plurality of types (e.g., the first type and the second type).

The specific type (or the specific PUCCH resource set) may be determined on the basis of at least one of the following options 1 to 3.

### <Option 1>

Information related to the specific type (or the specific PUCCH resource set) may be notified to or configured for the UE by higher layer signaling. For example, a network (e.g., a base station) may configure the first type as the specific type. When multiplexing the first type of UCI and the second type of UCI to the same PUCCH resource, the UE determines the PUCCH resource on the basis of a PUCCH resource set configured for the first type. As the specific type, the second type may be configured.

### <Option 2>

The specific type may be determined on the basis of a given rule. For example, the specific type may be defined by specifications beforehand. In other words, when multiplexing the first type of UCI and the second type of UCI to the same PUCCH resource, the UE may select a PUCCH resource associated with a PUCCH resource set corresponding to a type (or a service) defined by the specifications beforehand.

Alternatively, the specific type may be determined on the basis of at least one of a payload (or total payloads), a PUCCH format, and a transmission length (or a symbol length or a PUCCH length) of at least one of the first type of UCI and second type of UCI.

For example, assume a case where the first type of UCI with a 1 to 2-bit payload and a PUCCH format to be applied being PF 0 or PF 1 and the second type of UCI with a 10-bit payload and a PUCCH format to be applied being PF 2, PF 3, or PF 4 collide with each other. In such a case, the UE may apply a PUCCH resource set configured for the second type with a larger payload (or corresponding to a PF with higher capacity).

Alternatively, assume a case where the first type of UCI with a 10-bit payload and the second type of UCI with a 1 to 2-bit payload collide with each other. In such a case, the UE may apply a PUCCH resource set configured for the first type with a larger payload.

Alternatively, assume a case where the first type of UCI with a 10-bit payload and a PUCCH format to be applied being PF 2 and the second type of UCI with a 10-bit payload and a PUCCH format to be applied being PF 2, PF 3, or PF 4 collide with each other. In such a case, the UE may apply a PUCCH resource set configured for the first type to which a specific PF (e.g., only PF 2) is applied.

### <Option 3>

The specific type or PUCCH resource set candidates may be determined on the basis of multiplexing rules. The multiplexing rules may be values of a payload boundary of PUCCH resource sets each configured for each type.

For example, in the PUCCH resource sets each configured for each type, PUCCH resource sets each corresponding to a total value of a first type of UCI bits and a second type of UCI bits are selected. The specific PUCCH resource set (or type) may be determined on the basis of payload values configured for the selected each type of PUCCH resource set.

The UE may control transmission of the first type of UCI and the second type of UCI by using a PUCCH resource included in the specific PUCCH resource set. The payload values of the PUCCH resource sets may be upper limits of payloads of the PUCCH resource sets. For example, the UE may select a PUCCH resource set with a lower upper payload limit (or a type corresponding to the PUCCH resource set) out of PUCCH resource sets to which a total value of a first type of UCI payloads and a second type of UCI payloads corresponds.

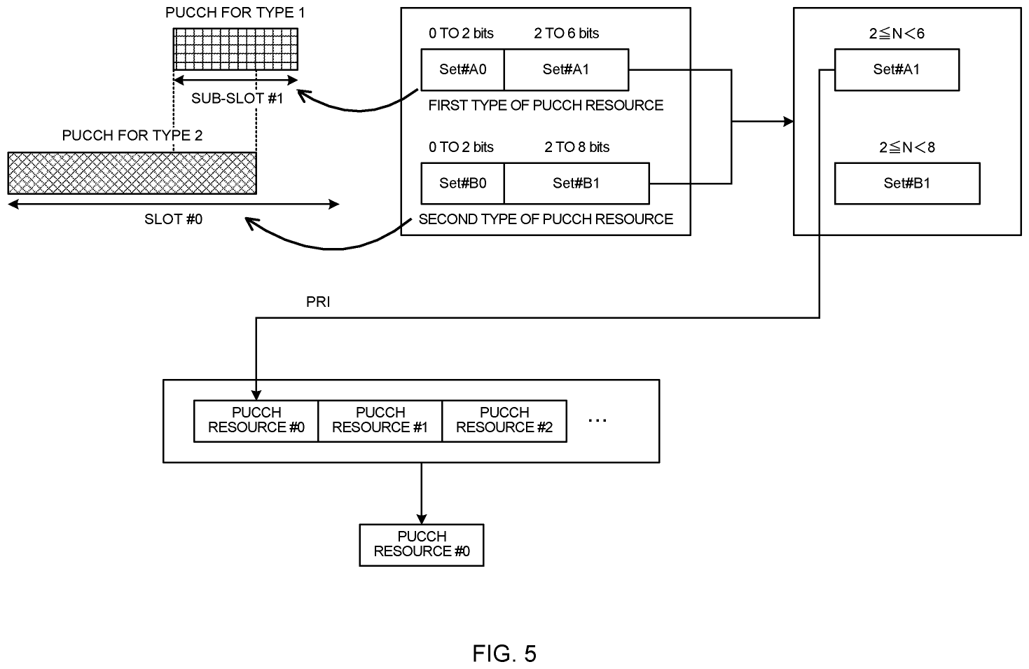

FIG. 5 is a diagram to show an example of a method for determining a PUCCH resource for multiplexing the first type of UCI and the second type of UCI in a case where a PUCCH for the first type of UCI and a PUCCH for the second type of UCI collide with each other.

Here, FIG. 5 shows a case where the first type of UCI and the second type of UCI are allocated to a common PUCCH resource when the PUCCH for the first type of UCI allocated in a sub-slot unit and the PUCCH for the second type of UCI allocated in a slot unit collide with each other. Needless to say, a unit of allocation of the first and second types of PUCCHs is not limited to this.

Descriptions below will be described by using, as an example, a case where two PUCCH resource sets (e.g., Set #A0 and Set #A1) are configured for the first type and two PUCCH resource sets (e.g., Set #B0 and Set #B1) are configured for the second type. Note that the number of PUCCH resource sets configured for each type is not limited to two, and may be one, or may be three or more. The numbers of PUCCH resource sets configured for each type may be different from each other.

Here, assume a case where the sum of the first type of UCI bits and the second type of UCI bits is N (e.g., 4 bits) and 0<Set #A0≤2, 2<Set #A1≤6, 0<Set #B0≤2, and 2<Set #B1≤8.

When the sum of each type of UCI bits is 4, the total value is included in ranges of Set #A1 and Set #B1. In this case, an upper payload limit of Set #A1 (here, 6) and an upper payload limit of Set #B1 (here, 8) may be compared with each other to determine the specific PUCCH resource set (or the specific type).

For example, the UE may select a PUCCH resource set with a lower upper payload limit (here, Set #A1). Therefore, an increase in overhead of a PUCCH used for transmission of the first type of UCI and the second type of UCI can be suppressed.

### <Procedure for Determining PUCCH Resource>

After determining the specific type on the basis of at least one of the above-described options 1 to 3 (e.g., step 0), the UE selects one PUCCH resource set from one or more PUCCH resource sets configured for the specific type (e.g., step 1). The UE selects one PUCCH resource from one or more PUCCH resources included in the selected PUCCH resource set (e.g., step 2). Note that in option 3, steps 0 and 1 may be performed at the same time.

### [Step 1]

The UE may determine, on the basis of a total value (total UCI payload) of the first type of UCI bits and the second type of UCI bits, a PUCCH resource set to be used. For example, when the UCI is HARQ-ACK, a total value (N) of each type of UCI corresponds to a total value of a first type of HARQ-ACK bits (N_{type1_HARQ-ACK}) and a second type of HARQ-ACK bits (N_{type2_HARQ-ACK}) multiplexed to an identical PUCCH resource.

The first type of HARQ-ACK bits (N_{type1_HARQ-ACK}) may be HARQ-ACK bits for URLLC (N_{URLLC_HARQ-ACK}), and the second type of HARQ-ACK bits (N_{type2_HARQ-ACK}) may be HARQ-ACK bits for eMBB (N_{eMBB_HARQ_ACK}). It is only necessary that the UE selects a PUCCH resource set to which the total value N (N=N_{URLLC_HARQ-ACK}+N_{eMBB_HARQ-ACK}) corresponds.

### [Step 2]

The UE may determine a given PUCCH resource from one or more PUCCH resources included in the selected PUCCH resource set. For example, the UE may select the given PUCCH resource on the basis of information notified by downlink control information (DCI).

The information notified by the DCI may be a value of a given field (also referred to as, for example, a PUCCH resource identifier (PUCCH resource indicator/indication (PRI)) field and so on) in the DCI. One or more PUCCH resource candidates included in the PUCCH resource set may be configured for the UE by higher layer signaling or the like from the base station.

It is conceivable that the UE detects PRIs in a plurality (e.g., two) of pieces of DCI. For example, it is also assumed that a PRI for a first type of HARQ-ACK for a first type of PDSCH is notified by DCI to schedule the first type of PDSCH and a PRI for a second type of HARQ-ACK for a second type of PDSCH is notified by DCI to schedule the second type of PDSCH.

In this case, the UE may determine, on the basis of a given rule, a PRI to be applied. For example, the UE may determine the PUCCH resource by using a PRI notified by DCI related to a type (or specific type) corresponding to the PUCCH resource set selected in step 0 or step 1 (a first PRI determination method).

For example, assume a case where a PUCCH resource set related to the first type is selected when the first type of HARQ-ACK and the second type of HARQ-ACK are multiplexed to the same PUCCH resource. In such a case, the UE determines the PUCCH resource on the basis of a PRI included in DCI used for scheduling of the first type of PDSCH.

Similarly, assume a case where a PUCCH resource set related to the second type is selected when the first type of HARQ-ACK and the second type of HARQ-ACK are multiplexed to the same PUCCH resource. In such a case, the UE determines the PUCCH resource on the basis of a PRI included in DCI used for scheduling of the second type of PDSCH.

Alternatively, the PRI (or DCI) used for the PUCCH resource determination may be defined by specifications beforehand, or may be configured for the UE from the base station (a second PRI determination method).

For example, when the first type of HARQ-ACK and the second type of HARQ-ACK are multiplexed to the same PUCCH resource, a structure in which a PRI included in DCI used for scheduling of the first type of PDSCH is always applied may be employed. Alternatively, a structure in which a PRI included in DCI used for scheduling of the second type of PDSCH is always applied may be employed.

As described above, the DCI used for the PUCCH resource determination is associated with a PUCCH resource set type or is defined beforehand, thereby allowing the PUCCH resource to be appropriately selected.

### <UE Procedure>

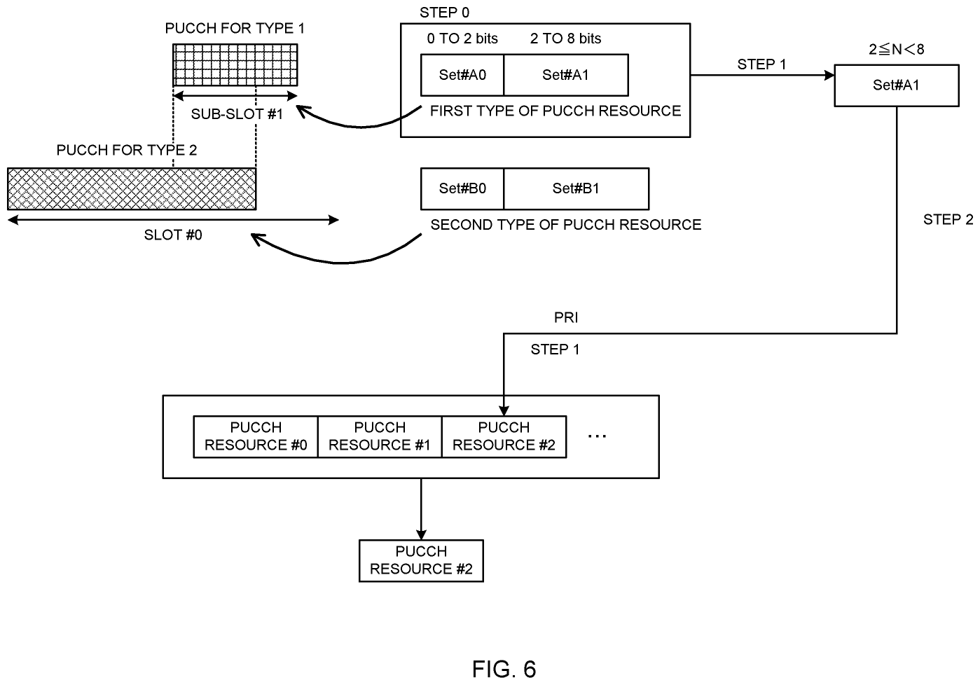

FIG. 6 shows an example of a case where the first type of UCI and the second type of UCI are multiplexed to the same PUCCH resource. FIG. 6 shows an example of a case (option 2) where a specific type out of a plurality of types is configured beforehand. Descriptions below will be described by using, as an example, a case where the first type is the specific type.

FIG. 6 shows a case where the first type of UCI and the second type of UCI are allocated to a common PUCCH resource when the PUCCH for the first type of UCI allocated in a sub-slot unit and the PUCCH for the second type of UCI allocated in a slot unit collide with each other. Here, FIG. 6 shows a case where two PUCCH resource sets (e.g., Set #A0 and Set #A1) are configured for the first type and two PUCCH resource sets (e.g., Set #B0 and Set #B1) are configured for the second type. The number of configured PUCCH resource sets and the like are not limited to this.

The UE determines a type corresponding to the PUCCH resource sets (step 0). Here, the PUCCH resource sets (Set #A0 and Set #A1) configured for the first type are selected.

Next, the UE selects one PUCCH resource set on the basis of a total value (N) of payloads of the first type of UCI and the second type of UCI (step 1). Here, the UE selects a PUCCH resource set to which the total value (N) of the payloads corresponds out of the PUCCH resource sets (Set #A0 and Set #A1) selected in step 0.

For example, assume a case where N is 6 bits and 0<Set #A0≤2 and 2<Set #A1≤8. In such a case, the UE selects Set #A1 as the PUCCH resource set.

Next, the UE selects, on the basis of information notified by DCI, a given PUCCH resource from PUCCH resources included in Set #A1 (step 2). FIG. 6 shows a case where PUCCH resources #0 to #7 are included in Set #A1 and PUCCH resource #2 is designated by DCI (e.g., PRI=010). For example, when using the first PRI determination method, it is only necessary that the UE determines the PUCCH resource on the basis of a PRI included in DCI to schedule the first type of PDSCH.

FIG. 5 shows an example of a case (option 3) where the specific type is determined on the basis of multiplexing rules.

The UE determines, on the basis of a total value of payloads of each type of UCI and a value of a payload boundary of each type of PUCCH resource set, PUCCH resource sets being candidates to be used (step 0). As mentioned above, FIG. 5 shows a case where the PUCCH resource set (Set #A1) configured for the first type and the PUCCH resource set (Set #B1) configured for the second type are selected.

Next, the UE selects one PUCCH resource set on the basis of a payload boundary value (e.g., an upper payload limit) of the selected PUCCH resource sets (step 1). Here, FIG. 5 shows a case where Set #A1 with a lower upper payload limit is selected.

Next, the UE selects, on the basis of information notified by DCI, a given PUCCH resource from PUCCH resources included in Set #A1 (step 2). FIG. 5 shows a case where PUCCH resources #0 to #7 are included in Set #A1 and PUCCH resource #0 is designated by DCI (e.g., PRI=000). For example, when using the first PRI determination method, it is only necessary that the UE determines the PUCCH resource on the basis of a PRI included in DCI to schedule the first type of PDSCH.

As described above, when a plurality of pieces of UCI corresponding to different types are allocated to the same PUCCH resource, the PUCCH resource is determined on the basis of a PUCCH resource set corresponding to the specific type on the basis of a given condition, thereby allowing UCI transmission to be appropriately controlled.

### (Second Aspect)

In a second aspect, when UCI (e.g., HARQ-ACK) each corresponding to a different type (e.g., a first type and a second type) is transmitted with use of the same PUCCH resource, the PUCCH resource is determined in consideration of PUCCH resource sets each configured for a corresponding type.

When a PUCCH resource for the first type of UCI and a PUCCH resource for the second type of UCI collide with each other, a UE may determine, in consideration of a PUCCH resource set configured for the first type and a PUCCH resource set configured for the second type, the PUCCH resource to be used.

For example, the UE selects, on the basis of a total value of payloads of each type of UCI, the PUCCH resource set from PUCCH resource sets each configured for each type. In this case, the UE may control the determination of the PUCCH resource set and PUCCH resource on the basis of the number of the selected PUCCH resource sets (or PUCCH resource sets corresponding to the total number).

PUCCH resource determination procedure in a case (case 1) where PUCCH resource set(s) selected on the basis of a total value of payloads of the first type of UCI and the second type of UCI are a plurality (e.g., two) of PUCCH resource sets, in a case (case 2) where the PUCCH resource set(s) is one PUCCH resource set, and in a case (case 3) where the PUCCH resource set(s) do not exist will be described below.

### <Case 1>

When a plurality (e.g., two) of PUCCH resource sets corresponding to the total value of the payloads of the first type of UCI and the second type of UCI exist, the UE may determine, on the basis of a given condition, the PUCCH resource to be applied. The given condition may be a transmission condition or a parameter for PUCCH resources each selected from each PUCCH resource set.

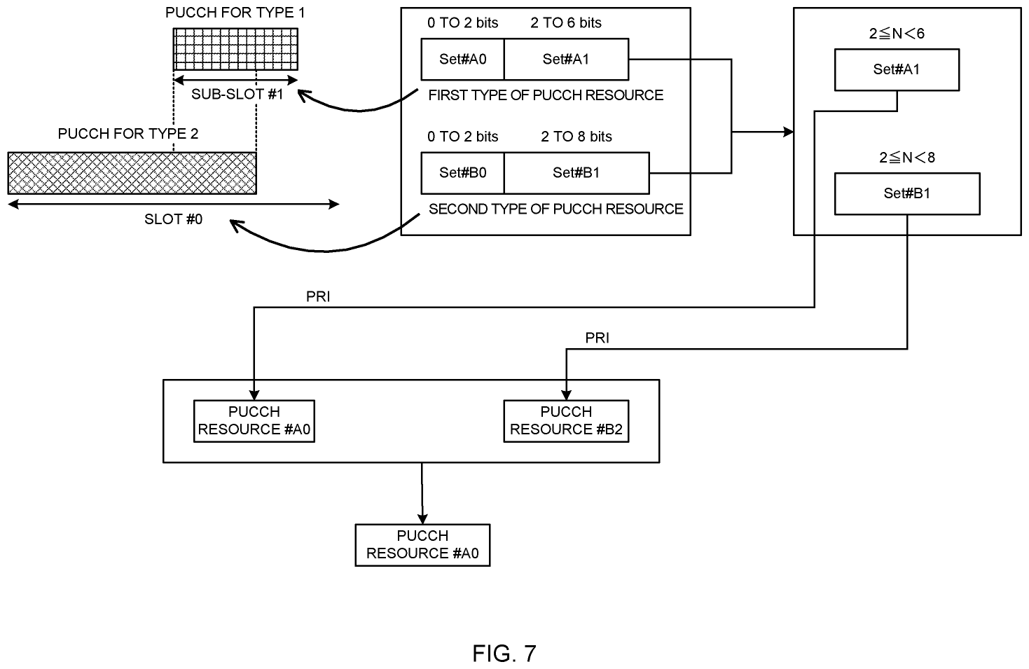

FIG. 7 shows an example of a case where the first type of UCI and the second type of UCI are multiplexed to the same PUCCH resource. FIG. 7 shows a case where one PUCCH resource set is selected from each of the first type and the second type.

Descriptions below will be described by using, as an example, a case where two PUCCH resource sets (e.g., Set #A0 and Set #A1) are configured for the first type and two PUCCH resource sets (e.g., Set #B0 and Set #B1) are configured for the second type. The number of PUCCH resource sets configured for each type is not limited to two, and may be one, or may be three or more. The numbers of PUCCH resource sets configured for each type may be different from each other.

Here, assume a case where the sum of a payload (e.g., HARQ-ACK bits) of the first type of UCI and a payload of the second type of UCI is N (e.g., 4 bits) and 0<Set #A0≤2, 2<Set #A1≤6, 0<Set #B0≤2, and 2<Set #B1≤8. When the sum of payloads of each type of UCI is 4 bits, the total value is included in a payload range of Set #A1 and a payload range of Set #B1.

In this case, the UE selects Set #A1 and Set #B1 as PUCCH resource set candidates. When a plurality of the selected PUCCH resource sets exist, the UE may determine the PUCCH resource to be applied by using the following procedure (step 2-1 to step 2-2).

### [Step 2-1]

The UE selects each PUCCH resource from each of the selected PUCCH resource set. For example, the UE determines one PUCCH resource from a plurality of PUCCH resources included in Set #A1 corresponding to the first type. The UE may determine the PUCCH resource on the basis of a PRI included in DCI to schedule the first type of PDSCH.

Similarly, the UE determines one PUCCH resource from a plurality of PUCCH resources included in Set #B1 corresponding to the second type. The UE may determine the PUCCH resource on the basis of a PRI included in DCI to schedule the second type of PDSCH.

FIG. 7 shows a case where PUCCH resource #A0 is selected from Set #A1 and PUCCH resource #B2 is selected from Set #B1.

### [Step 2-2]

The UE determines, on the basis of a given condition, a specific PUCCH resource out of PUCCH resources each selected from each type of PUCCH resource set. For example, the UE may determine, on the basis of a transmission condition or a parameter for each PUCCH resource, the PUCCH resource to be used.

The transmission condition or the parameter for the PUCCH resource may be at least one of a start symbol of the PUCCH resource, a period of PUCCH transmission (or a PUCCH resource length or a PUCCH length), a resource size, and an associated type.

For example, the UE may select a PUCCH resource with the earliest start symbol out of a plurality of PUCCH resources. When a plurality of PUCCH resources with the same start symbol exist, the UE may select a PUCCH resource with a shorter PUCCH length (or PUCCH transmission period). When a plurality of PUCCH resources with the same PUCCH transmission period exist, the UE may select a PUCCH resource corresponding to a specific type (e.g., either of the first type and second type).

Alternatively, the UE may select a PUCCH resource with the shortest PUCCH length. Alternatively, the UE may select a PUCCH resource with the most resources capable of being used for UCI.

FIG. 7 shows a case where the UE prioritizes selection of a PUCCH resource with a shorter PUCCH length (or PUCCH resource length or PUCCH transmission period). For example, when a PUCCH length of PUCCH resource #A0 is shorter than that of PUCCH resource #B2, the UE selects PUCCH resource #A0.

As described above, the PUCCH resource is determined in consideration of a plurality of types of PUCCH resource sets, thereby allowing kinds of PUCCH resources to be applied to be increased, and thus UCI transmission can be appropriately controlled.

### <Case 2>

When only one PUCCH resource set corresponding to the total value of the payloads of the first type of UCI and the second type of UCI exists, the UE may apply a PUCCH resource included in the PUCCH resource set.

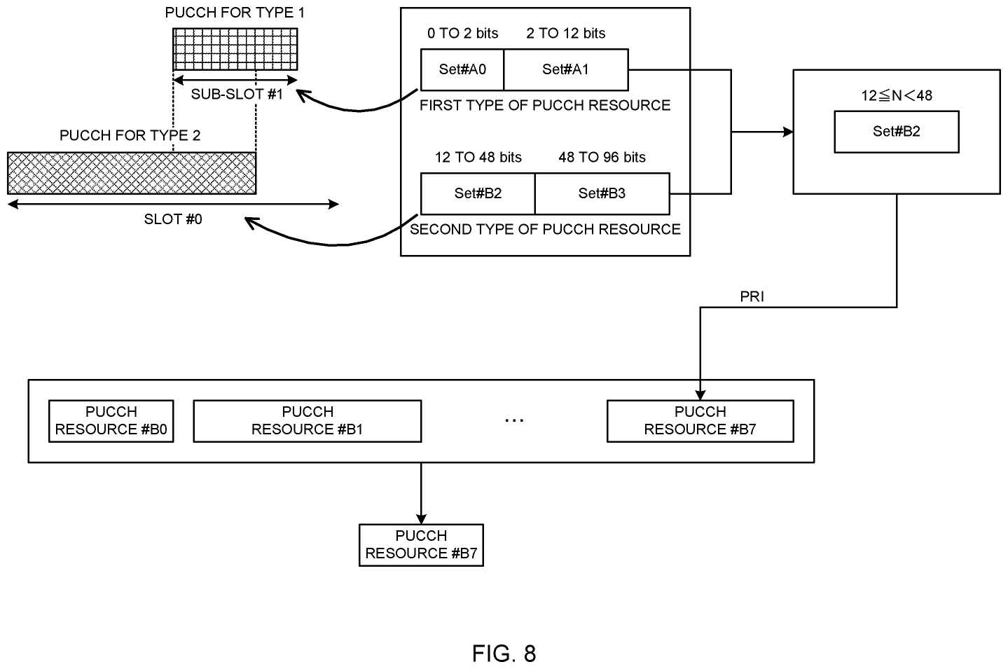

FIG. 8 shows a case where one PUCCH resource set is selected from each of the first type and the second type. Descriptions below will be described by using, as an example, a case where two PUCCH resource sets (e.g., Set #A0 and Set #A1) are configured for the first type and two PUCCH resource sets (e.g., Set #B2 and Set #B3) are configured for the second type.

Here, assume a case where the sum of payloads of the first type of UCI and payloads of the second type of UCI is N (e.g., 32 bits) and 0<Set #A0≤2, 2<Set #A1≤12, 12<Set #B2≤48, and 48<Set #B3≤96. When the sum of payloads of respective types of UCI is 32 bits, the total value is included in a payload range of Set #B2.

In this case, the UE selects Set #B2 as the PUCCH resource set. When the selected PUCCH resource set is one PUCCH resource set, the UE may select, on the basis of DCI, one PUCCH resource from PUCCH resources included in the PUCCH resource set (here, Set #B2).

FIG. 8 shows a case where PUCCH resources #0 to #7 are included in Set #B2 and PUCCH resource #7 is designated by DCI (e.g., PRI=111). The DCI may be DCI to schedule a type (second type) of PDSCH to which the selected PUCCH resource set (here, Set #B2) corresponds.

### <Case 3>

A case where PUCCH resource sets corresponding to the total value of the payloads of the first type of UCI and the second type of UCI do not exist is conceivable. In such a case, the UE may control a transmission process (e.g., PUCCH resource set selection or the like) by applying bundling to at least one of the first type of UCI and the second type of UCI (option 2-1). Alternatively, the UE may control a transmission process (e.g., PUCCH resource set selection or the like) by dropping either of the first type of UCI and the second type of UCI (option 2-2).

### [Option 2-1]

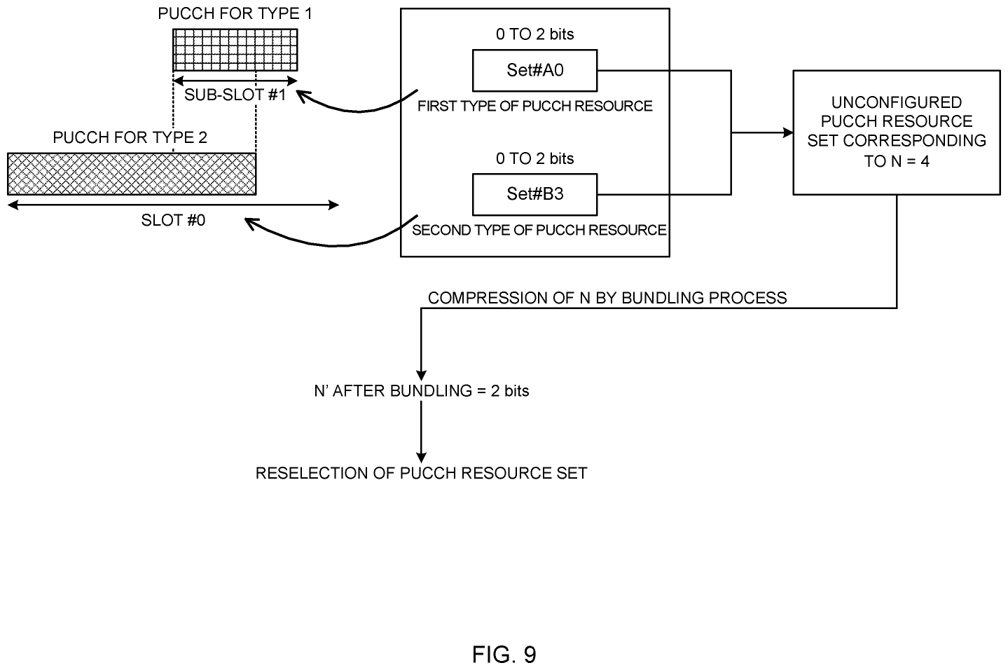

FIG. 9 shows a case where PUCCH resource sets corresponding to the total value of the payloads of the first type of UCI and the second type of UCI do not exist.

Descriptions below will be described by using, as an example, a case where one PUCCH resource set (e.g., Set #A0) is configured for the first type and one PUCCH resource set (e.g., Set #B0) is configured for the second type.

Here, assume a case where the sum of payloads of the first type of UCI and payloads of the second type of UCI is N (e.g., 4 bits), and 0<Set #A0≤2 and 0<Set #B0≤2. When the sum of payloads of respective types of UCI is 4 bits, the total value is not included in any payload ranges of PUCCH resource sets.

In this case, the UE may perform a bundling process to at least one of the first type of UCI and the second type of UCI to compress UCI payloads. The UE may apply at least one of the following bundling methods 1 to 3 as the bundling process.

Bundling Method 1

The UE may perform the bundling process relative to only the first type of UCI (e.g., HARQ-ACK). For example, the UE may apply bundling to the first type of HARQ-ACK, so that the first type of HARQ-ACK is 1 bit. In this case, the sum (N) of a payload (1 bit) of the first type of UCI and a payload (N_{type2_HARQ-ACK}) of the second type of UCI is N=1+N_{type2_HARQ-ACK} bits.

Bundling Method 2

The UE may perform the bundling process relative to only the second type of UCI (e.g., HARQ-ACK). For example, the UE may apply bundling to the second type of HARQ-ACK, so that the second type of HARQ-ACK is 1 bit. In this case, the sum (N) of a payload (N_{type1_HARQ-ACK}) of the first type of UCI and a payload (1 bit) of the second type of UCI is N=N_{type1_HARQ-ACK}+1 bits.

Bundling Method 3

The UE may perform the bundling process on each of the first type of HARQ-ACK and the second type of HARQ-ACK. For example, the UE may apply bundling to the first type of HARQ-ACK, so that the first type of HARQ-ACK is 1 bit, and may apply bundling to the second type of HARQ-ACK, so that the second type of HARQ-ACK is 1 bit. In this case, the sum (N) of a payload (1 bit) of the first type of UCI and a payload (1 bit) of the second type of UCI is N=2 bits.

The UE may control reselection of a corresponding PUCCH resource set and PUCCH resource on the basis of payloads after the bundling process (e.g., the sum (N′) of payloads of the first type of UCI and the second type of UCI). The reselection of the PUCCH resource set and PUCCH resource may use at least one of the above-mentioned case 1 and case 2.

In FIG. 9, a PUCCH resource set to which the sum of payloads of the first type of UCI and the second type of UCI (here, 4 bits) corresponds is not configured, and thus a case is illustrated where the UE applies the bundling process to each type of UCI (bundling method 3). As a PUCCH resource set to which the sum of the payloads of the first type of UCI and the second type of UCI after the bundling process (here, N′=2 bits) corresponds, Set #A0 and Set #B0 exist.

In such a case, it is only necessary that the UE determines the PUCCH resource set and PUCCH resource by applying the method shown in the above-described case 1.

### [Option 2-2]

The UE may drop either the first type of UCI or the second type of UCI. For example, the UE may drop the second type of UCI, and may control so as to transmit only the first type of UCI.

In FIG. 9, the UE may drop the second type of UCI, and may control so as to transmit the first type of UCI with use of a PUCCH resource set (here, Set #A0) configured for the first type.

### <NW Procedure>

A network (e.g., a base station) may control so that only one PUCCH resource set to which the sum of payloads of the first type of UCI and the second type of UCI corresponds exists. In this case, the UE may assume that a plurality of PUCCH resource sets to which the sum of the payloads of the first type of UCI and the second type of UCI corresponds are not configured. In other words, a structure in which only the above-described case 2 is supported may be employed. Therefore, when the first type of UCI and the second type of UCI are multiplexed to a common PUCCH resource, determination of the PUCCH resource set can be simplified.

As described above, the PUCCH resource is selected in consideration of PUCCH resource sets configured for each of a plurality of types, and thus PUCCH resources for multiplexing a plurality of types of UCI can be flexibly configured.

### (Third Aspect)

In a third aspect, a case where, when a first type of UCI and a second type of UCI are transmitted with use of the same PUCCH resource, the PUCCH resource is determined on the basis of a specific PUCCH resource set will be described.

When a PUCCH resource for the first type of UCI and a PUCCH resource for the second type of UCI collide with each other, a UE may transmit the first type of UCI and the second type of UCI by using a PUCCH resource included in the specific PUCCH resource set. The specific PUCCH resource set(s) may be a PUCCH resource set configured separately (or independently) from a PUCCH resource set configured for the first type and a PUCCH resource set configured for the second type.

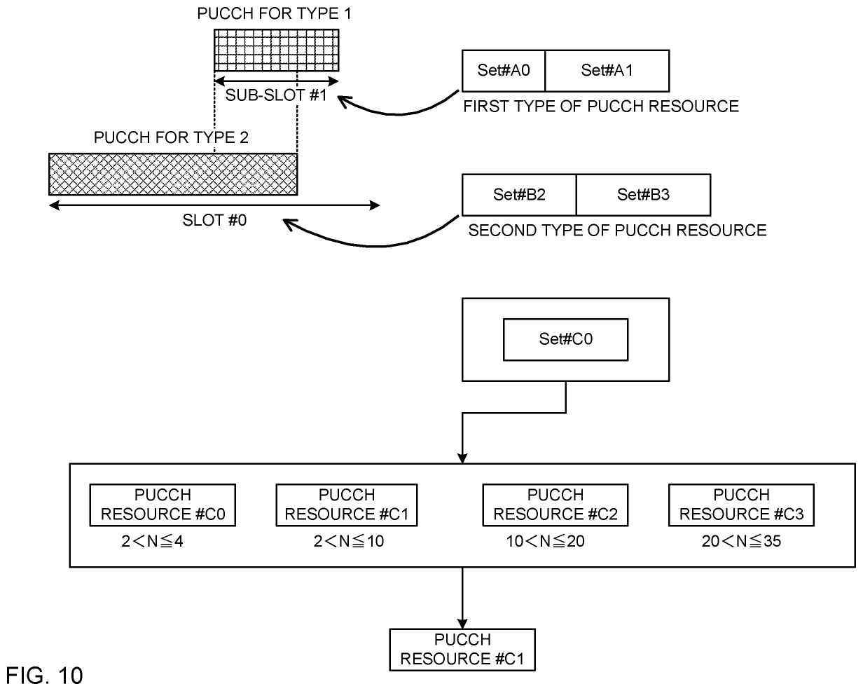

FIG. 10 shows an example of a case where transmission of the first type of UCI and the second type of UCI is controlled with use of a PUCCH resource associated with the PUCCH resource set configured separately from the PUCCH resource sets configured for each of the first type and the second type.

FIG. 10 shows a case where two PUCCH resource sets (e.g., Set #A0 and Set #A1) are configured for the first type and two PUCCH resource sets (e.g., Set #B2 and Set #B3) are configured for the second type. FIG. 10 shows a case where one PUCCH resource set (Set #C0) is configured separately from the PUCCH resource set relative to the first type and PUCCH resource set relative to the second type. Note that the number of configured PUCCH resource sets is not limited to a structure shown in FIG. 10.

The PUCCH resource set (Set #C0) may be configured for the UE by higher layer signaling or the like from a base station. A plurality of PUCCH resources with different payloads (or the number of bits capable of being stored) may be associated with Set #C0. The plurality of the PUCCH resources may be configured for the UE by higher layer signaling or the like.

FIG. 10 shows a case where PUCCH resources #C0, #C1, #C2, and #C3 with different payloads are included in Set #C0. FIG. 10 shows, as an example, a case where 2<PUCCH resource #C0≤4, 4<PUCCH resource #C1≤10, 10<PUCCH resource #C2≤20, and 20<PUCCH resource #C3≤35.

The UE selects a PUCCH resource to which the sum (N) of payloads of the first type of UCI and the second type of UCI corresponds. Here, illustrated is a case where the sum of the payloads is 10 bits and the UE selects PUCCH resource #1.

As described above, when different types of UCI are transmitted by being multiplexed to a common PUCCH resource, a PUCCH resource set configured separately from PUCCH resource sets each configured for a corresponding type may be applied.

Therefore, a PUCCH resource set to be applied can be flexibly configured. A plurality of payloads (e.g., large-size payloads) of each PUCCH resource included in the PUCCH resource set are configured, and thus a PUCCH resource corresponding to the sum of payloads of a plurality of types of UCI can be appropriately prepared.

### <Variations>

FIG. 10 shows a case where one PUCCH resource set to be applied in a case where different types of UCI are multiplexed to the same PUCCH resource is configured, but PUCCH resource sets to be configured may be two or more PUCCH resource sets. In this case, two or more PUCCH resource sets (specific PUCCH resource sets) may be configured separately from a PUCCH resource set configured for the first type and a PUCCH resource set configured for the second type.

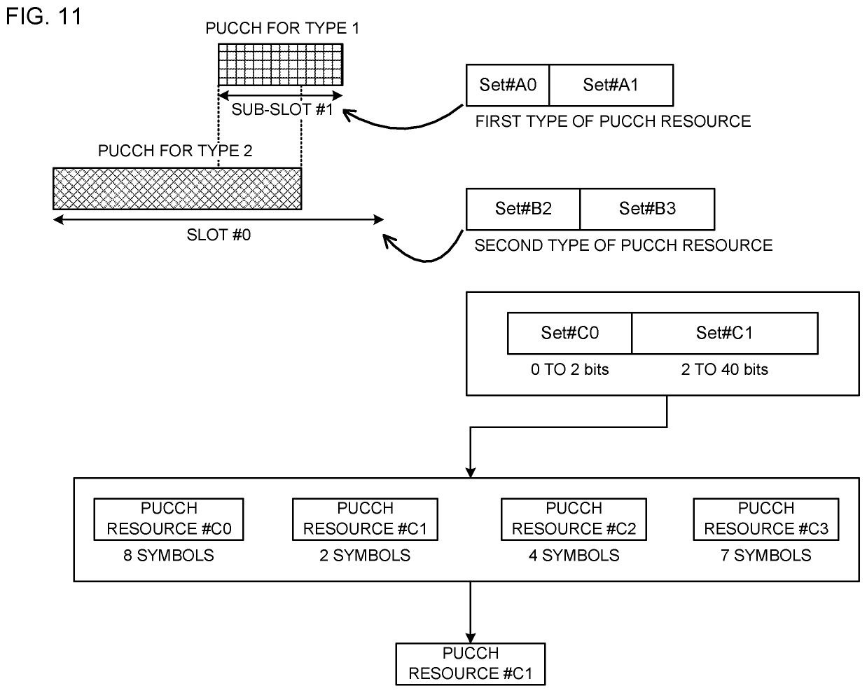

FIG. 11 shows an example of a case where a PUCCH resource included in any one of a plurality (here, two) of PUCCH resource sets configured separately from the PUCCH resource sets configured for each of the first type and the second type is used.

FIG. 11 shows a case where two PUCCH resource sets (e.g., Set #A0 and Set #A1) are configured for the first type and two PUCCH resource sets (e.g., Set #B2 and Set #B3) are configured for the second type. FIG. 11 shows a case where two PUCCH resource sets (Set #C0 and Set #C1) are configured separately from the PUCCH resource set relative to the first type and PUCCH resource set relative to the second type. Note that the number of configured PUCCH resource sets is not limited to a structure shown in FIG. 11.

A structure in which Set #C0 and Set #C1 correspond to different payloads may be employed. For example, the UE may determine the PUCCH resource sets on the basis of payloads of UCI to be multiplexed. One or more PUCCH resources may be associated with each of Set #C0 and Set #C1.

In FIG. 11, assume a case where the sum of a payload (e.g., HARQ-ACK bits) of the first type of UCI and a payload of the second type of UCI is N (e.g., 10 bits), and 0<Set #C0≤2 and 2<Set #C1≤40. When the sum of payloads of each type of UCI is 10 bits, the total value is included in a payload range of Set #C1.

In this case, the UE selects Set #C1 as the PUCCH resource set. When a plurality of PUCCH resources are included in the selected PUCCH resource set, the UE may select one PUCCH resource on the basis of a given condition.

For example, the UE may determine, on the basis of a transmission condition or a parameter for each PUCCH resource, the PUCCH resource to be used. The transmission condition or the parameter for the PUCCH resource may be at least one of a start symbol of the PUCCH resource, a period of PUCCH transmission (or a PUCCH resource length or a PUCCH length), a resource size, and an associated type.

For example, the UE may select a PUCCH resource with the earliest start symbol out of a plurality of PUCCH resources. When a plurality of PUCCH resources with the same start symbol exist, the UE may select a PUCCH resource with a shorter PUCCH length (or PUCCH transmission period). When a plurality of PUCCH resources with the same PUCCH transmission period exist, the UE may select a PUCCH resource corresponding to a specific type (e.g., either of the first type and second type).

Alternatively, the UE may select a PUCCH resource with the shortest PUCCH length. FIG. 11 show a case where PUCCH resource #C1 with the shortest PUCCH length out of a plurality of PUCCH resources #C0, #C1, #C2, and #C3 included in Set #C1 is selected.

Alternatively, the UE may determine, on the basis of information notified from the base station (e.g., at least one of higher layer signaling and DCI), the PUCCH resource to be used. For example, PUCCH resource candidates may be configured for the UE by the higher layer signaling, and the UE may determine a specific PUCCH resource on the basis of information notified by the DCI.

As described above, when different types of UCI are transmitted by being multiplexed to a common PUCCH resource, a PUCCH resource set configured separately from PUCCH resource sets each configured for each type may be applied. Therefore, a PUCCH resource set to be applied can be flexibly configured. A plurality of payloads (e.g., large-size payloads) of each PUCCH resource included in the PUCCH resource set are configured, and thus a PUCCH resource corresponding to the total of payloads of a plurality of types of UCI can be appropriately prepared.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

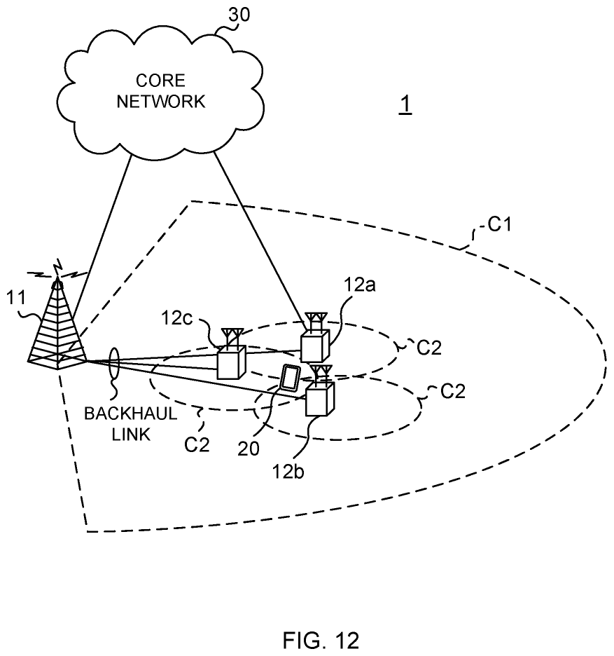

FIG. 12 is a diagram to show an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHz), and FR2 may be a frequency band which is higher than 24 GHz (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a given search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be also referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be also referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### (Base Station)

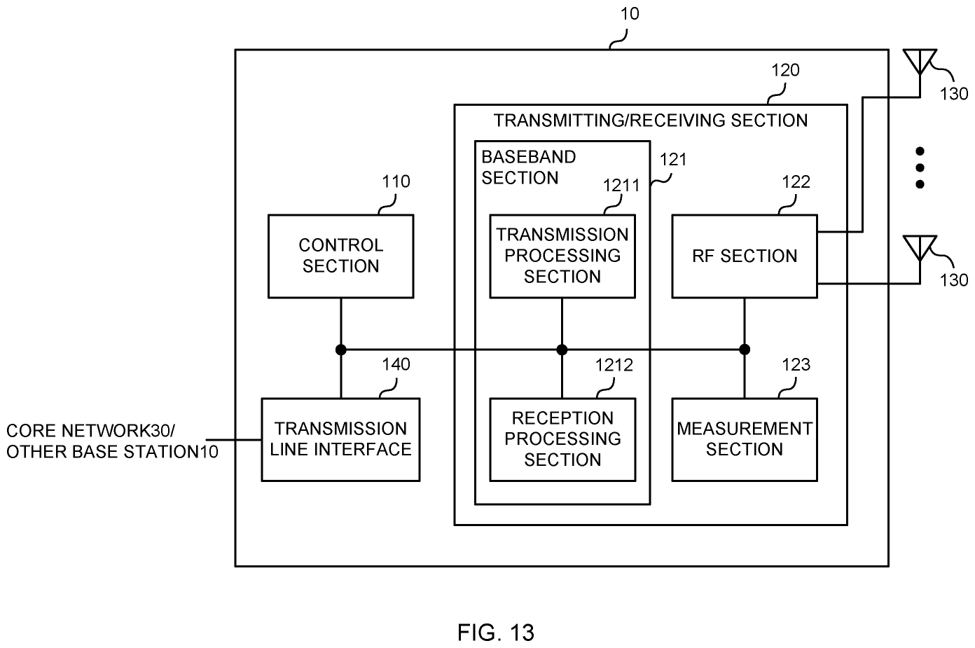

FIG. 13 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

Note that the transmitting/receiving section 120 receives uplink control information corresponding to a first type and uplink control information corresponding to a second type multiplexed to a same PUCCH resource. The transmitting/receiving section 120 may transmit information related to PUCCH resource sets each configured for each type and information related to a PUCCH resource associated with each PUCCH resource by using at least one of higher layer signaling and downlink control information.

When a first uplink control channel resource for first uplink control information corresponding to the first type and a second uplink control channel resource for second uplink control information corresponding to the second type collide with each other, the control section 110 may control selection of a specific uplink control channel resource set and uplink control channel resource used for transmission of the first uplink control information and the second uplink control information.

### (User Terminal)

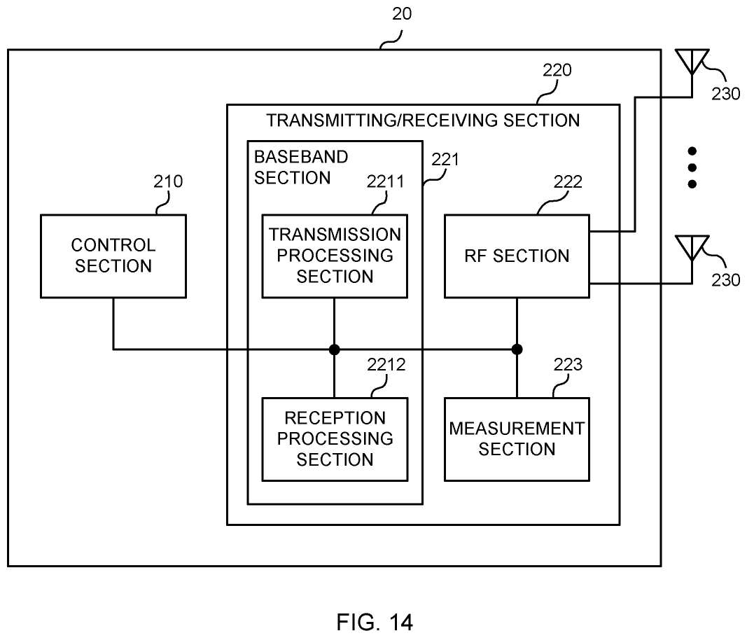

FIG. 14 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211 and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a given channel (for example, PUSCH), the DFT processing as the above-described transmission processing to transmit the channel by using a DFT-s-OFDM waveform if transform precoding is enabled, and otherwise, does not need to perform the DFT processing as the above-described transmission process.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply a receiving process such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

Note that the transmitting/receiving section 220 transmits uplink control information corresponding to a first type and uplink control information corresponding to a second type by using a same PUCCH resource. The transmitting/receiving section 220 may receive information related to PUCCH resource sets each configured for each type and information related to a PUCCH resource associated with each PUCCH resource by using at least one of higher layer signaling and downlink control information.

When a first uplink control channel resource for first uplink control information corresponding to the first type and a second uplink control channel resource for second uplink control information corresponding to the second type collide with each other, the control section 210 may select an uplink control channel resource included in a specific uplink control channel resource set.

For example, the control section 210 may consider, as the specific uplink control channel resource set, only one of one or more uplink control channel resource sets configured for the first type and one or more uplink control channel resource sets configured for the second type.

Alternatively, the control section 210 may consider, as the specific uplink control channel resource set, both of one or more uplink control channel resource sets configured for the first type and one or more uplink control channel resource sets configured for the second type.

Alternatively, the control section 210 may consider, as the specific uplink control channel resource set, one or more uplink control channel resource sets configured separately from an uplink control channel resource set configured for the first type and uplink control channel resource set configured for the second type.

The control section 210 may determine the specific uplink control channel resource set on the basis of the sum of bits of the first uplink control information and bits of the second uplink control information.

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

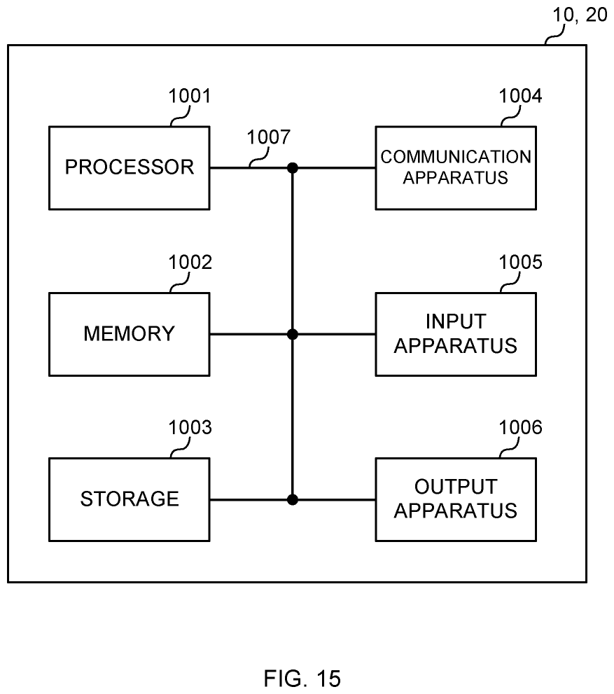

For example, a base station, a user terminal, and so on according to one embodiment of the present disclosure may function as a computer that executes the processes of the radio communication method of the present disclosure. FIG. 15 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing given software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### (Variations)

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a given signal or channel. For example, numerology may indicate at least one of a subcarrier spacing (SCS), a bandwidth, a symbol length, a cyclic prefix length, a transmission time interval (TTI), the number of symbols per TTI, a radio frame structure, a particular filter processing performed by a transceiver in the frequency domain, a particular windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIs.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for given numerology in a given carrier. Here, a common RB may be specified by an index of the RB based on the common reference point of the carrier. A PRB may be defined by a given BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a given signal/channel outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to given values, or may be represented in another corresponding information. For example, radio resources may be specified by given indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CEs).

Also, reporting of given information (for example, reporting of “X holds”) does not necessarily have to be reported explicitly, and can be reported implicitly (by, for example, not reporting this given information or reporting another piece of information).

Determinations may be made in values represented by one bit (0 or 1), may be made in Boolean values that represent true or false, or may be made by comparing numerical values (for example, comparison against a given value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be device mounted on a moving object or a moving object itself, and so on. The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor, and the like.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words “uplink” and “downlink” may be interpreted as the words corresponding to the terminal-to-terminal communication (for example, “side”). For example, an uplink channel, a downlink channel and so on may be interpreted as a side channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B is each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

1. A terminal comprising:
a control section that selects an uplink control channel resource included in a specific uplink control channel resource set when a first uplink control channel resource for first uplink control information corresponding to a first type and a second uplink control channel resource for second uplink control information corresponding to a second type collide with each other; and
a transmitting section that transmits the first uplink control information and the second uplink control information by using the selected uplink control channel resource.

2. The terminal according to claim 1, wherein the control section considers, as the specific uplink control channel resource set, only one of one or more uplink control channel resource sets configured for the first type and one or more uplink control channel resource sets configured for the second type.

3. The terminal according to claim 1, wherein the control section considers, as the specific uplink control channel resource set, both of one or more uplink control channel resource sets configured for the first type and one or more uplink control channel resource sets configured for the second type.

4. The terminal according to claim 1, wherein the control section considers, as the specific uplink control channel resource set, one or more uplink control channel resource sets configured separately from an uplink control channel resource set configured for the first type and uplink control channel resource set configured for the second type.

5. The terminal according to claim 1, wherein the control section determines the specific uplink control channel resource set on the basis of the sum of bits of the first uplink control information and bits of the second uplink control information.

6. A radio communication method comprising:
selecting an uplink control channel resource included in a specific uplink control channel resource set when a first uplink control channel resource for first uplink control information corresponding to a first type and a second uplink control channel resource for second uplink control information corresponding to a second type collide with each other; and
transmitting the first uplink control information and the second uplink control information by using the selected uplink control channel resource.

7. The terminal according to claim 2, wherein the control section determines the specific uplink control channel resource set on the basis of the sum of bits of the first uplink control information and bits of the second uplink control information.

8. The terminal according to claim 3, wherein the control section determines the specific uplink control channel resource set on the basis of the sum of bits of the first uplink control information and bits of the second uplink control information.

9. The terminal according to claim 4, wherein the control section determines the specific uplink control channel resource set on the basis of the sum of bits of the first uplink control information and bits of the second uplink control information.
